(19) United States
(12) Patent Application Publication
(10) Pub. No.: US 2017/0254194 A1
(43) Pub. Date: Sep. 7, 2017

(54) DEFORMABLE DOWNHOLE STRUCTURES INCLUDING ELECTRICALLY CONDUCTIVE ELEMENTS, AND METHODS OF USING SUCH STRUCTURES

(71) Applicant: Baker Hughes Incorporated, Houston, TX (US)

(72) Inventors: Oleg A. Mazyar, Katy, TX (US); Sankaran Murugesan, Katy, TX (US); Valery N. Khabashesku, Houston, TX (US); Darryl N. Ventura, Houston, TX (US); Rostyslav Dolog, Houston, TX (US); Leonty A. Tabarovsky, Cypress, TX (US)

(21) Appl. No.: 15/266,547

(22) Filed: Sep. 15, 2016

Related U.S. Application Data
(63) Continuation-in-part of application No. 15/063,034, filed on Mar. 7, 2016.

(51) Int. Cl. E21B 47/12; G01L 1/14; G01V 3/28; E21B 47/00; E21B 47/09

(52) U.S. Cl. CPC E21B 47/122; E21B 47/0006; E21B 47/09; G01V 3/28; G01L 1/14; B82Y 30/00

(57) ABSTRACT

A deformable downhole article for use in a wellbore includes a tubular component configured for placement in a wellbore, a deformable material disposed around an outer surface of the tubular component, and an electrically conductive element comprising a carbon nanotube (CNT) material bonded to the deformable material. To form such a deformable downhole article, a deformable material is disposed around an outer surface of a tubular component, and an electrically conductive element comprising a carbon nanotube (CNT) material is bonded to the deformable material. In use, the deformable downhole article may be positioned within a wellbore, and the deformable material may be expanded to an expanded state. Expansion of the deformable material may strain the carbon nanotube (CNT) material of the electrically conductive element, and an electrical property of the electrically conductive element may be measured to deduce information about the state of the deformable material.

### CROSS-REFERENCE TO RELATED APPLICATION

This application is a continuation-in-part of U.S. patent application Ser. No. 15/063,034, filed Mar. 7, 2016, pending, the disclosure of which is hereby incorporated herein in its entirety by this reference.

### TECHNICAL FIELD

The disclosure, in various embodiments, relates generally to materials for monitoring the expansion of deformable downhole structures disposed in a wellbore. More particularly, embodiments of the disclosure relate to downhole structures including a carbon nanotube material incorporated into a deformable material and methods of forming and using carbon nanotube materials and a deformable material.

### BACKGROUND

The drilling of wells for oil and gas production conventionally employs longitudinally extending sections or so-called “strings” of drill pipe to which, at one end, is secured a drill bit of a larger diameter. After a selected portion of a wellbore has been drilled, and in some instances reamed to a larger diameter than that initially drilled with a drill bit (which is such instances is termed a “pilot” bit), the wellbore is usually lined or cased with a string or section of casing or liner. Such a casing or liner exhibits a larger diameter than the drill pipe used to drill the wellbore, and a smaller diameter than the drill bit or diameter of a reamer used to enlarge the wellbore. Conventionally, after the casing or liner string is placed in the wellbore, the casing or liner string is cemented into place to seal between the exterior of the casing or liner string and the wellbore wall.

Tubular strings, such as drill pipe, casing, or liner, may be surrounded by an annular space between the exterior wall of the pipe and the interior wall of the well casing or the wellbore wall, for example. Frequently, it is desirable to seal such an annular space between upper and lower portions of the well depth. The annular space may be sealed or filled with a downhole article, such as a conformable device. Conformable devices include packers, bridge plugs, sand screens, and seals. Swellable packers and bridge plugs are particularly useful for sealing an annular space because they swell (e.g., expand) upon exposure to wellbore fluids, wellbore temperatures, and the like and fill the cross-sectional area of the annular space.

### BRIEF SUMMARY

In some embodiments of the present disclosure, a deformable downhole article for use in a wellbore includes a tubular component configured for placement in a wellbore, a deformable material disposed around an outer surface of the tubular component, and an electrically conductive element comprising a carbon nanotube (CNT) material bonded to the deformable material.

Additional embodiments of the present disclosure include methods of forming such a deformable downhole article. For example, a deformable material may be disposed around an outer surface of a tubular component, and an electrically conductive element comprising a carbon nanotube (CNT) material may be bonded to the deformable material.

Yet further embodiments of the present disclosure include methods of using such a deformable downhole article in a wellbore. A deformable downhole article may be positioned within a wellbore. The deformable downhole article may include a tubular component, a deformable material disposed around an outer surface of the tubular component, and an electrically conductive element comprising a carbon nanotube (CNT) material bonded to the deformable material. The deformable material may be expanded to an expanded state in the wellbore. Expansion of the deformable material may apply stress to the carbon nanotube (CNT) material of the electrically conductive element, resulting in a responsive strain of the CNT material, and an electrical property of the electrically conductive element associated with the strain may be measured. The measurement of the electrical property may be used to deduce information about the state of the deformable material.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 illustrates an example of a wellbore including at least one deformable downhole article disposed therein;

FIG. 2A is a simplified and schematically illustrated cross-sectional side view of a deformable downhole article like that of FIG. 1 including a deformable material in a compressed state and having coiled fibers of CNT material disposed therein in a first strain state;

FIG. 2B is a simplified and schematically illustrated cross-sectional side view of the deformable downhole article of FIG. 2A illustrating the deformable material in an expanded state within a wellbore, and wherein the coiled fibers of CNT material disposed therein are in a second strain state that is different from the first strain state;

FIG. 2C is a simplified and schematically illustrated expanded view of the deformable downhole article of FIG. 2B according to some embodiments;

FIG. 2D is a simplified and schematically illustrated expanded view of the deformable downhole article of FIG. 2B according to some embodiments;

FIGS. 3A-3C are simplified and schematically illustrated circuit diagrams of a circuit including the coiled fibers of FIG. 2A-2C;

FIG. 4A is a simplified and schematically illustrated cross-sectional side view of another embodiment of a deformable downhole article including a deformable material in a compressed state and having a coiled fiber of CNT material disposed therein in a first strain state;

FIG. 4B is a simplified and schematically illustrated cross-sectional side view of the deformable downhole article of FIG. 3A illustrating the deformable material in an expanded state within a wellbore, and wherein the coiled fiber of CNT material disposed therein is in a second strain state that is different from the first strain state;

FIG. 4C is a simplified and schematically illustrated expanded view of the deformable downhole article of FIG. 4B;

FIGS. 5A-5C are simplified and schematically illustrated circuit diagrams of a circuit including the coiled fibers of FIG. 4A-4C;

FIG. 6 is a simplified and schematically illustrated expanded view of CNT materials disposed in a deformable material according to another embodiment;

FIGS. 7A-7C are simplified cross-sectional side views illustrating the formation of a deformable downhole article as described herein using a reaction injection molding process;

FIG. 8A is a perspective view of a deformable downhole article like that of FIG. 1 according to another embodiment;

FIG. 8B is a simplified and schematically illustrated view of the deformable downhole article of FIG. 8A according to some embodiments;

FIG. 8C illustrates an operation of disposing a deformable material on a tubular component of the deformable downhole article of FIG. 8A;

FIG. 8D is a simplified and schematically illustrated cross-sectional view of the downhole article of FIG. 8A according to some embodiments;

FIG. 9A is a simplified and schematically illustrated view of a deformable downhole article like that of FIG. 1 according to another embodiment;

FIG. 9B is a simplified and schematically illustrated cross-sectional view of the deformable downhole article of FIG. 9A; and

FIG. 9C illustrates an operation of disposing a deformable material on a tubular component of the deformable downhole article of FIG. 9A.

### DETAILED DESCRIPTION

The illustrations presented herein are not meant to be actual views of any particular component, device, or system, but are merely idealized representations which are employed to describe embodiments of the disclosure. Elements common between figures may retain the same numerical designation.

Deformable downhole articles, such as expandable (e.g., conformable) packers, bridge plugs and sandscreens, may include a deformable material that expands upon exposure to wellbore fluids, wellbore temperatures, activation fluids provided from a surface of a subterranean formation, and the like and may fill the cross-sectional area of an annular space between an outer surface of a tubular member and an interior wall of a wellbore, such as the exposed surface of the formation within the wellbore. In some instances, it may be desirable to verify expansion of the deformable material so as to ensure proper function of the deformable downhole article. Embodiments of the present disclosure may enable a user of the deformable downhole articles to confirm that the deformable material of the deformable downhole article has swelled (i.e., expanded) so as to ensure that the deformable downhole article will function as intended.

Carbon nanotubes (CNTs) may exhibit high electrical conductivity. In accordance with embodiments of the present disclosure, an electrically conductive element comprising a carbon nanotube (CNT) material may be bonded to the deformable material of a deformable downhole article, and, in use, stress applied to the electrically conductive element responsive to expansion of the deformable material may strain the carbon nanotube (CNT) material of the electrically conductive element. Straining of the CNT material may result in a change of at least one electrical property of the CNT material. For example, CNTs may exhibit a measurable change in electrical conductivity and resistivity when strained. An electrical property of the electrically conductive element may be measured, and the measurement of the electrical property may be used to deduce information about the state of the deformable material.

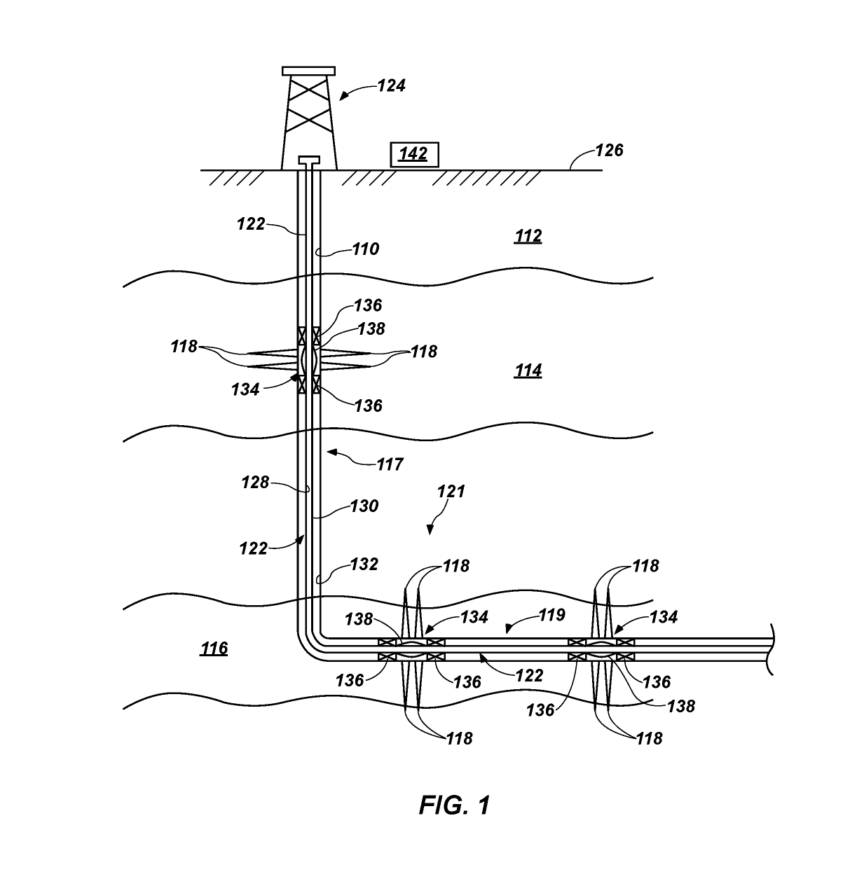

FIG. 1 illustrates a non-limiting example of a wellbore system 100 including a wellbore 110 that has been drilled through a subterranean formation 112 and into a pair of production formations or reservoirs 114, 116 from which it is desired to produce hydrocarbons or otherwise extract minerals, oil and gas, and the like. The wellbore 110 may be lined with a metal casing in some embodiments. A number of perforations 118 may penetrate and extend into the formation 114, 116 such that production fluids 121 may flow from the formations 114, 116 into the wellbore 110. The wellbore 110 may have a substantially vertical leg 117 and a deviated or substantially horizontal leg 119. The wellbore 110 may include a production string or assembly, generally indicated at 120, disposed therein by a tubular component 122 that extends downwardly from a drill rig 124 at the surface 126. The production assembly 120 defines an internal axial flow bore 128 along its length. An annulus 130 may be defined between the production assembly 120 and the wellbore casing, if present, or a wellbore wall 132. Production zones 134 are shown positioned at selected locations along the production assembly 120. Each production zone 134 may be isolated within the wellbore 110 by a pair of packer devices 136. Although only three production zones 134 are shown in FIG. 1, there may be a large number of such zones arranges in serial fashion along the vertical leg 117 and horizontal leg 119.

Each production zone 134 may include a flow control or production flow control device 138 to govern one or more aspects of a flow of one or more fluids into the production assembly 120. As used herein, the term “fluid” or “fluids” includes liquids, gases, hydrocarbons, multi-phase fluids, mixtures of two or more fluids, water, brine, engineered fluids such as drilling mud, fluids injected from the surface such as water, and naturally occurring fluids such as oil and gas.

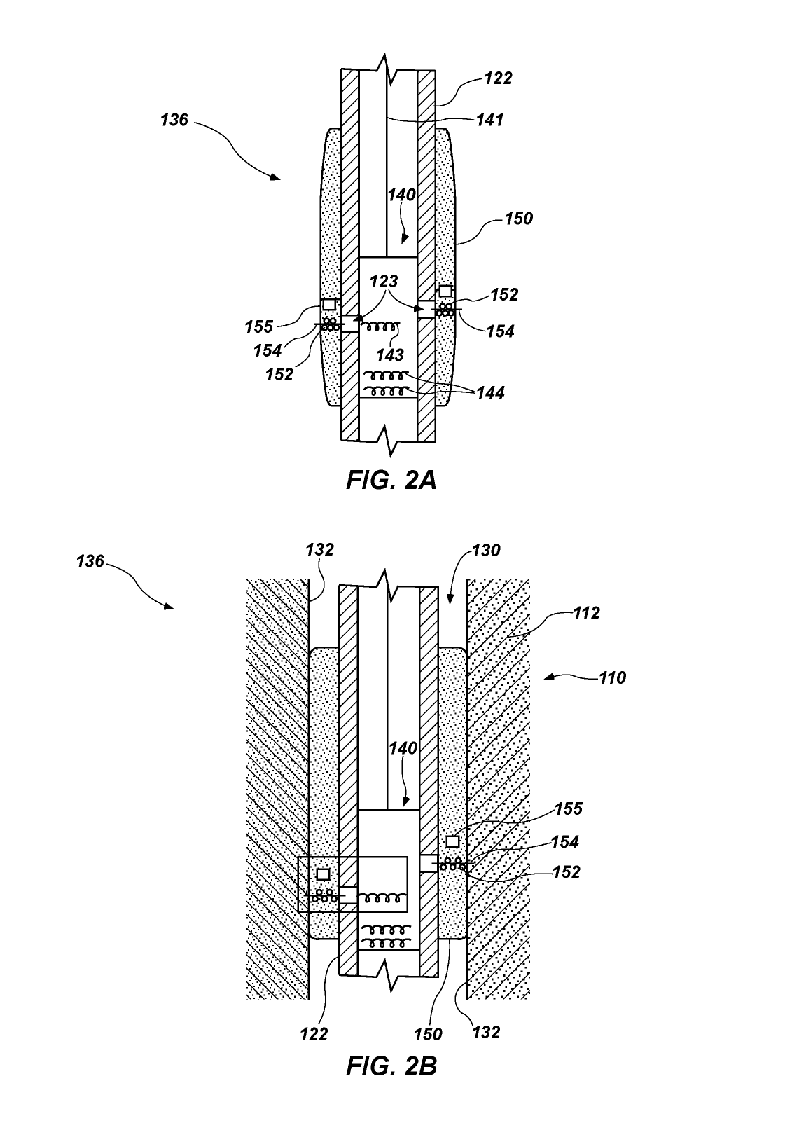

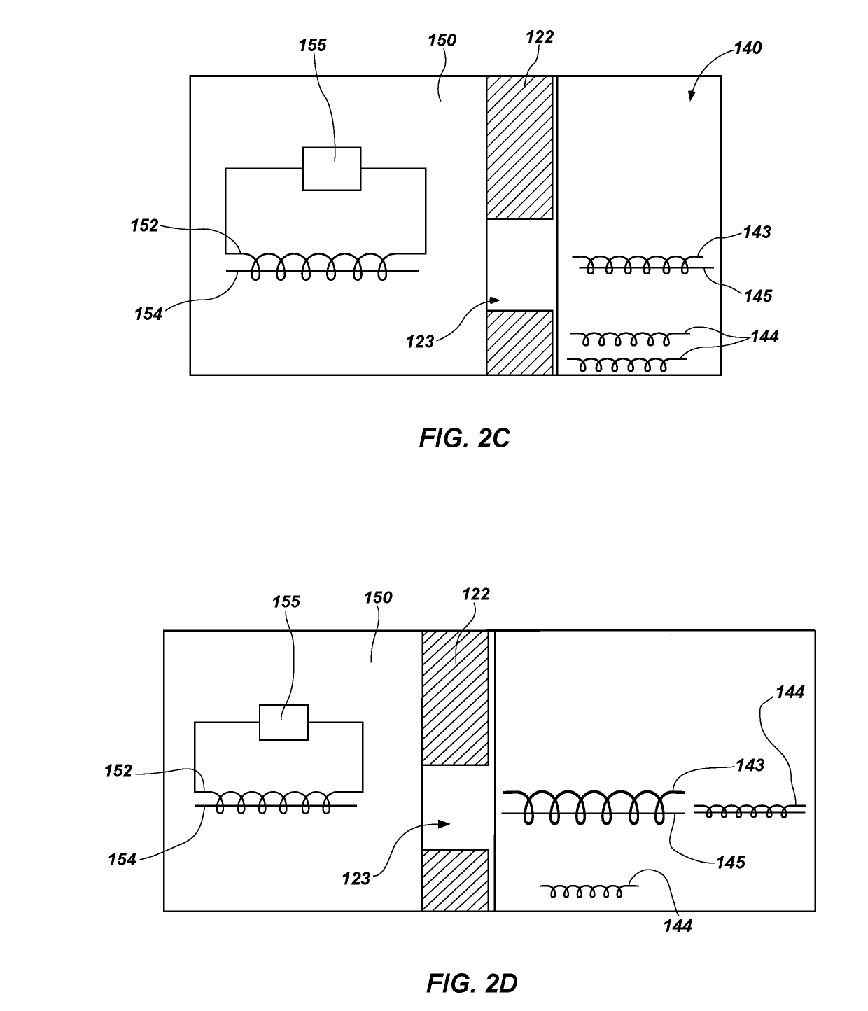

FIG. 2A illustrates a packer device 136 of the wellbore system 100 shown in FIG. 1. The packer device 136 is a deformable downhole article that includes a deformable material 150 disposed around an outer surface of a tubular component 122. FIG. 2A illustrates the deformable material 150 in an initial un-swollen or compressed state in which the deformable material 150 has a smaller diameter than the diameter of wall 132 of the wellbore 110. The deformable material 150 may surround a section of the tubular component 122 within the wellbore 110. The tubular component 122 may be a portion of a downhole casing or liner string, production pipe or tubing, or other tubular component within the wellbore 110. The tubular component 122 may comprise a plurality of orifices 123 configured to provide a flow of production fluids 121 from the formations 114, 116 through the production assembly 120. The deformable material 150 may be caused to swell (e.g. expand) after the tubular component 122 is positioned within the wellbore 110 at a selected location. The packer device 136 is positioned in the wellbore 110 while the deformable material 150 is in the initial un-swollen state in which the deformable material 150 has a smaller diameter than the diameter of wall 132 of wellbore 110 (FIG. 1).

As shown in FIG. 2B, after the packer device 136 is positioned at a selected location within the wellbore 110, the deformable material swells (e.g., expands) in the radial direction. In some embodiments, exposure to a wellbore fluid causes the deformable material 150 to expand and contact the wall 132 of the wellbore 110 to form a compressive, fluid-tight seal between the tubular component 122 and the wall 132. Thus, the outer diameter of the deformable material 150 may increase until it contacts the wall 132 of the wellbore 110 within subterranean formation 112. In other embodiments, an inner wall of tubing, casing, liner, or other surface may be disposed concentrically around the packer device 136, and the deformable material 150 may form a compressive, fluid-tight seal between the tubular component 122 and the inner wall of the tubing, casing, liner, or other surface. Thus, longitudinal flow of fluids (e.g., from formation 114, 116) through the annulus 130 past the exterior of packer device 136 (in the vertical directions from the perspective of FIG. 2B) is substantially prevented once the deformable material 150 is expanded.

The deformable material 150 may be formulated to expand until it fills the annular space 130. In some embodiments, the diameter of the wellbore 110 may be insufficient to allow the deformable material 150 to return fully to the expanded state. Further, the deformable material 150 may not swell (e.g., expand) uniformly as the diameter of the wellbore 110 may not be uniform. Swelling may result in an increase in the radius (measured from the tubular component 122 to an outer surface of the deformable material 150) of the deformable material 150 by between about 20% and about 300% of the initial radius of the deformable material 150. In some embodiments, the initial radius of the deformable material 150 may be in a range from about 0.5 inch (1.27 cm) to about 2 inches (5.08 cm), and, more particularly, about 1 inch (2.54 cm).

The deformable material 150 may comprise any suitable type of deformable material. As used herein, the term “deformable material” means and includes any material that may swell, expand, or otherwise increase in size in at least one dimension upon exposure to a downhole environment. By way of non-limiting examples, the deformable material 150 may comprise a conformable material as described in any of U.S. Pat. No. 9,090,012, titled “Process for the Preparation of Conformable Materials for Downhole Screens,” issued Jul. 28, 2015 (hereinafter the '012 patent); U.S. Pat. No. 8,684,075, titled “Sand Screen, Expandable Screen and Method of Making,” issued Apr. 1, 2014; U.S. Pat. No. 9,228,420, titled “Conformable Materials Containing Heat Transfer Nanoparticles and Devices Made Using Same,” issued Jan. 5, 2016; and U.S. Patent Publication No. 2015/0176363, titled “Swellable Downhole Structures Including Carbon Nitride Materials, and Methods of Forming and Using Such Structures,” filed Dec. 24, 2013, the entire disclosure of each of which is hereby incorporated herein by this reference. Such conformable materials may be used in conformable sand screens, such as the GEOFORM® conformable sand management system commercially available from Baker Hughes Inc. of Houston, Tex. By way of further non-limiting examples, the deformable material 150 may comprise a swellable material as described in any of U.S. Pat. No. 8,118,092, titled “Swelling Delay Cover for a Packer,” issued Feb. 21, 2012; U.S. Pat. No. 8,225,861, titled “Sealing Feed Through Lines for Downhole Swelling Packers,” issued Jul. 24, 2012, U.S. Patent Publication No. 2009/0084550, titled “Water Swelling Rubber Compound for Use in Reactive Packers and Other Downhole Tools,” filed Sep. 30, 2008; U.S. Patent Publication No. 2015/0210825, titled “Enhanced Water Swellable Compositions,” filed Mar. 13, 2014; U.S. Patent Publication No. 2009/0139708, titled “Wrap-On Reactive Element Barrier Packer and Method of Creating Same,” filed Jun. 6, 2008; and U.S. Pat. No. 8,181,708, titled “Water Swelling Rubber Compound for Use in Reactive Packers and Other Downhole Tools,” issued May 22, 2012 (hereinafter “the '708 patent”), the entire disclosure of each of which is hereby incorporated herein by this reference.

As a non-limiting example, the deformable material 150 may be an open-celled foam material. The open-celled foam material may comprise a viscoelastic shape memory polymeric material. Such viscoelastic shape memory polymer materials may exhibit a one-way shape memory effect. In other words, viscoelastic shape memory materials may be restored to an original shape and/or size when triggered by, for example, changing the temperature of the material, exposing the material to wellbore fluids, or exposing the material to electrical stimulus, a chemical stimulus, or another stimulus.

Open-celled foam materials that can expand (e.g., exhibit a shape memory effect) comprise a wide variety of polymers. Such polymers may include a polyurethane, a polyamide, a polyurea, a polyvinyl alcohol, a vinyl alcohol-vinyl ester copolymer, a phenolic polymer, a polybenzimidazole, a copolymer comprising polyethylene oxide units, and combinations thereof. For example, copolymers comprising polyethylene oxide units include polyethylene oxide/acrylic acid/methacrylic acid copolymer crosslinked with N,N′-methylene-bis-acrylamide, polyethylene oxide/methacrylic acid/N-vinyl-2-pyrrolidone copolymer crosslinked with ethylene glycol dimethacrylate, and polyethylene oxide/poly(methyl methacrylate)/N-vinyl-2-pyrrolidone copolymer crosslinked with ethylene glycol dimethacrylate. In some embodiments, the foamed conformable material may comprise a polyurethane made by reacting a polycarbonate polyol with a polyisocyanate. Such polymers may be chemically or at least physically crosslinked in order to exhibit shape memory properties.

In accordance with embodiments of the present disclosure, the tubular component 122 may be formed of a high strength material. In some embodiments, the tubular component 122 comprises a metal. A portion of the tubular component 122 may comprise a dielectric material. For example, the portion of tubular component 122 over which the deformable material 150 is formed may comprise the dielectric material.

In accordance with embodiments of the present disclosure, the packer device 136 further includes at least one electrically conductive element 152 comprising a carbon nanotube (CNT) material bonded to the deformable material 150. As discussed in further detail below, the electrically conductive element 152 is located and configured such that stress, responsive to which the electrically conductive element 152 is strained, will be applied to the electrically conductive element 152 upon swelling of the deformable material 150.

In the embodiment shown in FIGS. 2A and 2B, the electrically conductive element 152 comprises a plurality of fibers arranged in a coil. The fibers include crosslinked carbon nanotubes. FIGS. 2A and 2B are cross-sectional side views of the packer device 136 taken in a plane parallel to a longitudinal axis of the tubular component 122. As shown in FIGS. 2A and 2B, the coil may be oriented in the deformable material 150 such that an axis 154 of the coil extends perpendicular to the longitudinal axis of the tubular component 122 and radially outward from the tubular component 122 within the deformable material 150. In other words, the coil may be oriented in the deformable material 150 such that the axis 154 of the coil extends along a radius of the deformable material 150. Although only two coiled fibers are illustrated in FIGS. 2A and 2B, any number of coiled fibers of CNT material may be employed in embodiments of the present disclosure. In embodiments in which a plurality of fibers of CNT material are employed, the coiled fibers may be dispersed in the deformable material 150 concentrically about the tubular component 122 and along a length of the tubular component 122.

The coils of crosslinked carbon nanotubes that may be employed in embodiments of the present disclosure may be formed by rolling mats of carbon nanotube mats, such as those commercially available from MER Corporation, of Tucson, Ariz.

In some embodiments, the CNTs may be generally aligned with one another in at least one direction within the coiled fiber. In some embodiments, the CNTs may be generally aligned with one another along the length of the coiled fiber of CNT material, and/or aligned with one another in the direction of anticipated strain of the electrically conductive element 172 upon expansion of the deformable material 150. In other embodiments, the CNTs may be randomly oriented and dispersed in the coiled fiber of CNT material. Furthermore, the CNTs in the CNT material of the electrically conductive element 152 may comprise single-walled CNTs, double-walled CNTs, or multi-walled CNTs.

In some embodiments, the electrically conductive element 152 may be disposed within the deformable material 150. In such embodiments, the electrically conductive element 152 may be at least substantially surrounded (e.g., entirely surrounded) by the deformable material 150.

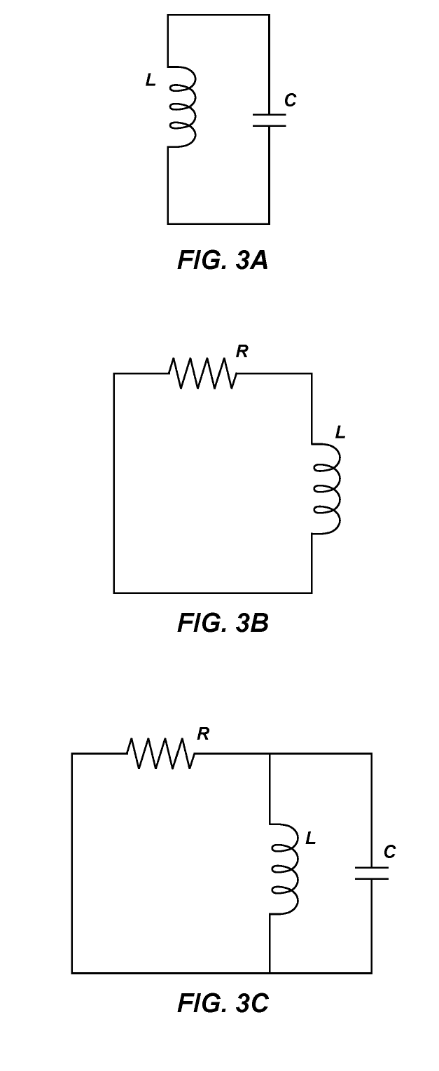

The electrically conductive element 152 may be covalently bonded to the deformable material 150. In other words, covalent atomic bonds may be provided directly between the electrically conductive element 152 and the deformable material 150. In this configuration, as the deformable material 150 expands from the state of FIG. 2A to the state of FIG. 2B, the expansion of the deformable material 150 may impart a stress, responsive to which the electrically conductive element 152 is strained, without extensive relative displacement of the electrically conductive element 152 relative to the adjacent deformable material 150 along the interface therebetween. In some embodiments, the CNTs of the CNT material of the conductive element 152 may be covalently bonded to the deformable material 150. The packer device 136 may further include at least one electronic component 155. FIGS. 2C and 2D are enlarged views of a portion of the packer device 136 outlined in FIG. 2B including the electronic component 155. In some embodiments, the at least one electronic component 155 may be a capacitor C coupled to the electrically conductive element 152, which may serve as an inductor L, to form a LC (e.g., resonant) circuit, illustrated in FIG. 3A. In other embodiments, the electronic device 156 may comprise a resistor R coupled to the electrically conductive element 152, which may serve as an inductor L, to form a RL (e.g., resistor-inductor) circuit, illustrated in FIG. 3B. In yet further embodiments, the electrically conductive element 152 may be coupled to a capacitor C and a resistor R to form a RLC circuit, as illustrated in FIG. 3C. In additional embodiments, the electrically conductive element 152 may be coupled to any combination of resistors and capacitors in parallel or in series. Electrical conductors (e.g., wires) may operably couple the electronically conductive element 152 and the electronic component 155 (e.g., the capacitor or resistor).

With continued reference to FIGS. 2A-2D, the packer device 136 may further comprise an induction logging tool 140. The induction logging tool 140 may be provided in and separated from the deformable material 150 by the tubular component 122. The induction logging tool 140 may comprise a wireline 141 extending from the induction logging tool 140 to the surface 126. Surface equipment 142 (FIG. 1) may include an electric power supply to provide electric power to one or more transmitter coils 143 and one or more receiver coils 144 in the induction logging tool 140. In other embodiments, the power supply and/or transmitter signal drivers and receiver processors may be located in the induction logging tool 140. The induction logging tool 140 may be configured to measure at least one electrical property (e.g., conductivity, resistivity, inductance, etc.) of the electrically conductive element 152. For example, the induction logging tool 140 may measure a change in electrical inductance of the electrically conductive element 152 when the electrically conductive element is strained. In other words, as the deformable material 150 expands from the state of FIG. 2A to the state of FIG. 2B, the length of the electrically conductive elements 152 may increase resulting in a change in at least one electrical property, such as inductance, of the electrically conductive element 152. The change in at least one electrical property of the electrically conductive element 152 may be correlated to a degree of expansion of the deformable material 150.

With reference to FIG. 2C, an axis 145 of the transmitter coil 143 may be coaxial with the axis 154 of the electrically conductive element 152 in some embodiments. The transmitter coil 143 and electrically conductive element 152 may further be aligned with the orifice 123 of the tubular component 122. In other embodiments, the transmitter coil 143 and the electrically conductive element 152 may not be coaxial and/or may not be aligned with the orifice 123. A diameter of the electrically conductive element 152 and/or the transmitter coil 143 may be less than a diameter of the orifice 123. By way of example, the diameter of the orifice 123 may be in a range from about 0.5 inch (1.27 cm) to about 2 inches (5.08 cm) and, more particularly, about 1 inch (2.54 cm). In other embodiments, the diameter of the electrically conductive element 152 and/or the transmitter coil 143 may be greater than a diameter of the orifice 123. In yet other embodiments, the diameter of the transmitter coil 143 may be greater than the diameter of the electrically conductive element 152, as illustrated in FIG. 2D.

With continued reference to FIG. 2D, in some embodiments, an axis 146 of at least one receiver coil 144 may also be coaxial with the axis 152 of the electrically conductive element 152 and the axis 145 of the transmitter coil 143. In other embodiments, at least one receiver coil 144 may not be coaxial with the axis 152 of the electrically conductive element 142 or the axis 145 of the transmitter coil 142. In yet other embodiments, the axis 146 of at least one receiver coil 144 may be oriented such that the axis 146 is parallel to magnetic field lines generated by the electrically conductive element 152. As strain on the electrically conductive element 152 may result in a measurable change in the electromagnetic field emitted about the electrically conductive element 152, orienting the axis 146 to be parallel to the magnetic field lines of the electromagnetic field emitted by the electrically conductive element 152 may improve the accuracy of a determination of the degree of expansion of the deformable material 150. The physical principles of the induction logging tool 140 are described, for example, in Doll, Introduction to Induction Logging and Application to Logging of Wells Drilled with Oil Based Mud, Vol. 1, Issue 6 (June 1949), pp. 148-162, the disclosure of which is incorporated herein its entirety by this reference. By way of non-limiting example, the induction logging tool 140 may be an induction logging tool as described in U.S. Pat. No. 7,190,169, titled “Method and Apparatus for Internal Calibration in Induction Logging Instruments,” issued Mar. 13, 2007; U.S. Pat. No. 8,487,625, titled “Performing Downhole Measurement Using Tuned Transmitters and Untuned Receivers,” issued Jul. 16, 2013; and U.S. Pat. No. 9,223,046, titled “Apparatus and Method for Capacitive Measuring of Sensor Standoff in Boreholes Filled with Oil Based Drilling Fluid,” issued Dec. 29, 2015, the entire disclosure of each of which is incorporated herein by this reference. Stress on the electrically conductive element 152 and resultant strain thereof may result in a measurable change in the induction or electromagnetic field emitted about the electrically conductive element 152, which may be measured as a function of power loss or resonant frequency measured in the induction logging tool 140.

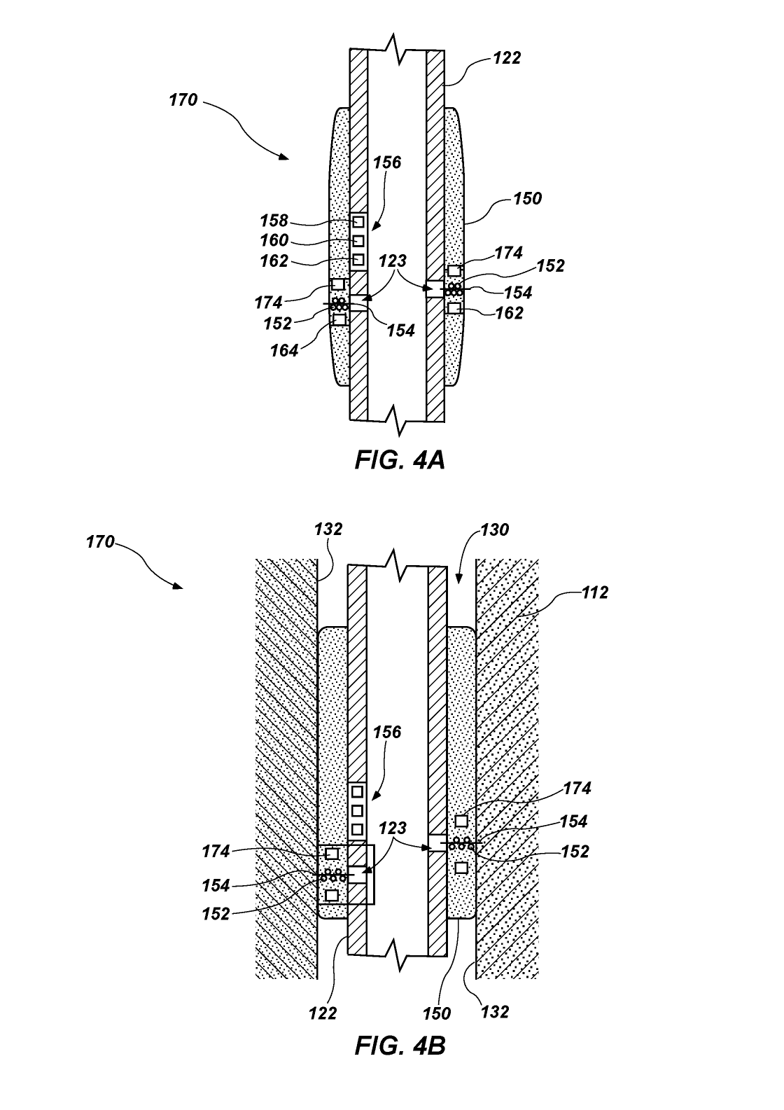

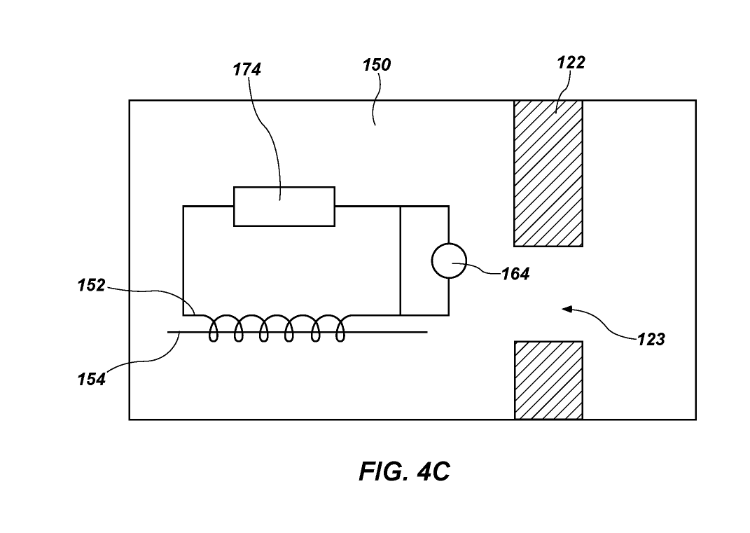

FIGS. 4A-4C are similar to FIGS. 2A-2C and illustrate another embodiment of a packer device 170 that may be employed in a wellbore system, such as the wellbore system 100 of FIG. 1. The packer device 170 is a deformable downhole article that, like the packer device of 136, includes a tubular component 122 and a deformable material 150 disposed around the tubular component 122 as previously described herein with reference to FIGS. 2A-2C. The packer device 170 also includes electrically conductive element 152 comprising a carbon nanotube (CNT) material bonded to the deformable material 150, and the electrically conductive element 152 is located and configured such that stress will be applied to the electrically conductive element 152 upon swelling of the deformable material 150.

FIG. 4C is an enlarged view of a portion of the packer device 170 outlined in FIG. 4B. With continued reference to FIGS. 4A through 4C, the packer device 170 may further include an electronic device 156 in lieu of the induction logging tool 140. The electronic device 156 may be operably coupled to the electrically conductive element 152 and configured to measure at least one electrical property (e.g., conductivity, resistivity, inductance, impedance, etc.) of the electrically conductive element 152. In some embodiments, the electronic device 156 may be located within the packer device 170, such as within a recess or other receptacle within the tubular component 122. In other embodiments, the electronic device 156 may be located in another component of the production assembly 120, such as in another sub in the production assembly 120. In yet further embodiments, the electronic device 156 may be located at the surface.

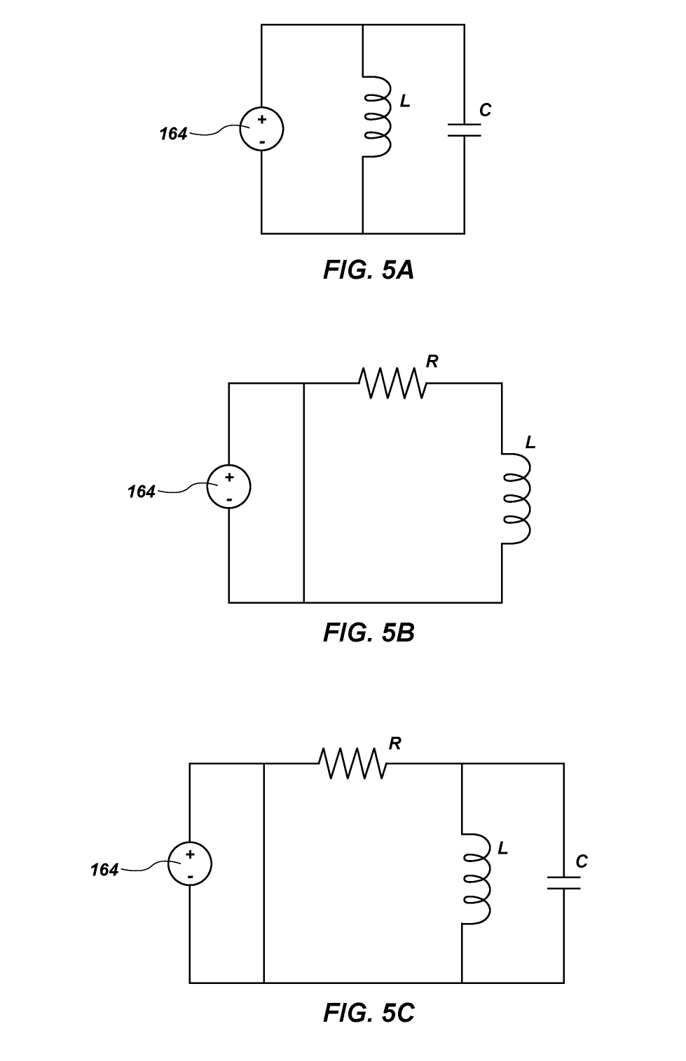

The electronic device 156 may comprise an electronic signal processor 158, a memory device 160, and a communication device 162. The packer device 170 may also comprise a battery or other power supply 164. The power supply 164 may be located in the electronic device 156 or in the deformable material 150. The packer device 170 may comprise at least one electrical component 174 coupled to the electrically conductive element 152 and the power supply 164. In some embodiments, the at least one electronic component 174 comprises a capacitor C coupled to the electrically conductive element 152, which may serve as an inductor L, to form a LC (e.g., resonant) circuit, as illustrated in FIG. 5A. In other embodiments, the electronic component 174 may comprise a resistor R coupled to the electrically conductive element 152, which may serve as an inductor L, to form a RL (e.g., resistor-inductor) circuit, as illustrated in FIG. 5B. In yet other embodiments, the electrically conductive element 152 may be coupled to a capacitor C and a resistor R to form a RLC circuit, as illustrated in FIG. 5C. Electrical conductors (e.g., wires) may operably couple the electronic component 174, the electrically conductive element 152, and the power supply 164. The wires may contact the electrically conductive element 152 at two or more locations, such that the power supply 164 may provide an electrical current through the electrically conductive element 152 via the wires. Electrical conductors may further couple the electronic component 174 and/or the electrically conductive element 152 to the electronic device 156.

The electronic device 156 may comprise a multimeter or voltmeter that allows the electronic device 156 to measure an electrical property of the electrically conductive element 152 during use of the packer device 136 and expansion of the deformable material 150. For example, in some embodiments the electronic device 156 may measure a change in inductance or resistivity of the electrically conductive element 152 by measuring a change in resonant frequency of the LC circuit, RL circuit, or RLC circuit. In other embodiments, the electronic device 156 may measure a change in impedance of the electrically conductive element 152. For example, in some embodiments, the change in impedance may be determined from a ratio of the current provided by the power supply 164 through the electrically conductive element 152 and the voltage measured by a voltmeter as a current is passed through the electrically conductive element 152. The communication device 162 may comprise a transmitter and/or a receiver that is used to transmit information relating to the measured electrical property of the electrically conductive element 152 to the surface 126 for analysis, and/or to receive information such as operational commands from the surface 126. The communication device 162 may comprise, for example, a mud-pulse telemetry system.

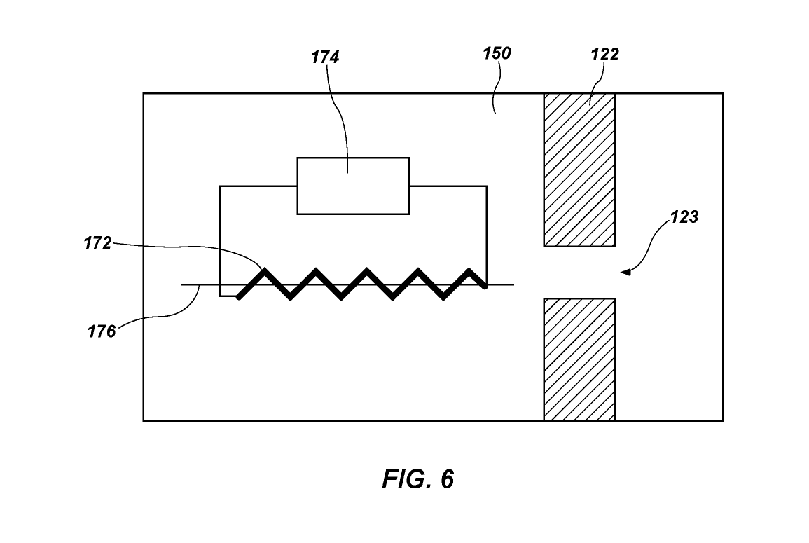

FIG. 6 illustrates another configuration of an electrically conductive element 172 disposed in the deformable material 150. The electrically conductive element 172 may have a zig-zag shape oscillating about an axis 176 of the electrically conductive element 172. The electrically conductive element 172 may be oriented in the deformable material 150 such that the axis 176 of the zig-zag shape extends perpendicular to the longitudinal axis of the tubular component 122 and radially outward from the tubular component 122 within the deformable material 150. In other words, the electrically conductive element 172 may be oriented in the deformable material 150 such that the axis 154 of the coil extends along a radius of the deformable material 150. The electrically conductive element 172 is located and configured such that stress will be applied to the electrically conductive element 172 upon swelling of the deformable material 150. Strain of the electrically conductive element 172 responsive to the applied stress may result in a measurable change in the induction or electromagnetic field emitted about the electrically conductive element 172, which may be measured as a function of power loss or resonant frequency measured in the induction logging tool 140, as described previously herein with reference to FIGS. 2A through 2C. Strain of the electrically conductive element 172 may also be measured by coupling the electrically conductive element 172 to an electrical component 174, a power supply 164, and an electronic device 156, as described previously herein with reference to FIGS. 4A through 4C. In yet other embodiments, electrically conductive elements disposed in the deformable material 150 may have any other shape configured such that stress will be applied to the electrically conductive element 172 upon swelling of the deformable material 150.

As previously mentioned, the CNTs in the CNT material of the electrically conductive elements 152, 172 may be crosslinked, such that direct covalent atomic bonds join adjacent CNTs directly together in the conductive elements 152, 172. Such crosslinking of the CNTs in the CNT material of the electrically conductive elements 152, 172 may cause the CNT material to exhibit increased mechanical strength (e.g., higher tensile strength or yield strength) compared to CNT materials having CNTs that are not crosslinked. Methods for crosslinking CNTs are known in the art and disclosed in, for example, D. N. Ventura et al., A Flexible Cross-linked Multi-Walled Carbon Nanotube Paper for Sensing Hydrogen, Carbon 50 (2012), pp. 2672-2674, the contents of which are incorporated herein in their entirety by this reference. For example, as disclosed therein, CNTs may be functionalized with amine groups to form aminated CNTs, and the aminated CNTs may be crosslinked with benzoquinone.

Additionally, the CNTs in the CNT material of the electrically conductive elements 152, 172 may be impregnated with metal nanoparticles. In other words, metal nanoparticles may be attached to outer walls of the CNTs. In some embodiments, the CNTs may be impregnated with at least one of platinum, copper, silver, gold, ruthenium, rhodium, tin, or palladium nanoparticles and combinations thereof. The attachment of metal nanoparticles to the CNTs may increase the electrical conductivity of the CNTs.

Embodiments of the present disclosure also include methods of forming deformable downhole articles as described herein, such as the packer devices 136, 170. For example, in accordance with such methods, a deformable material 150 may be disposed around an outer surface of a tubular component 122 configured for placement in a wellbore, and an electrically conductive element 152, 172 comprising a carbon nanotube (CNT) material may be bonded to the deformable material 150.

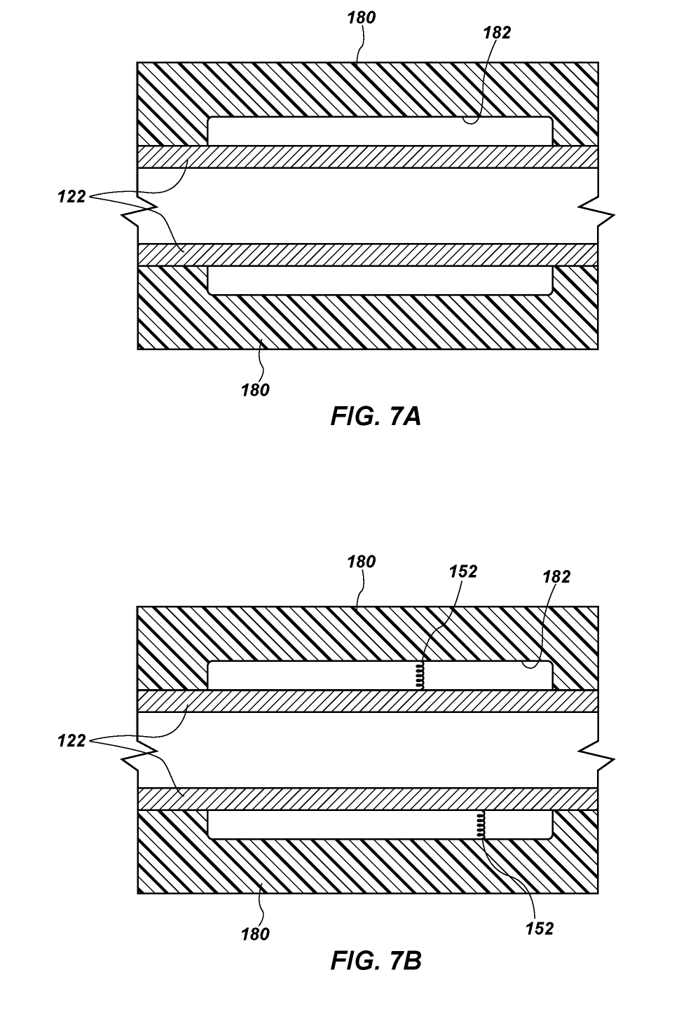

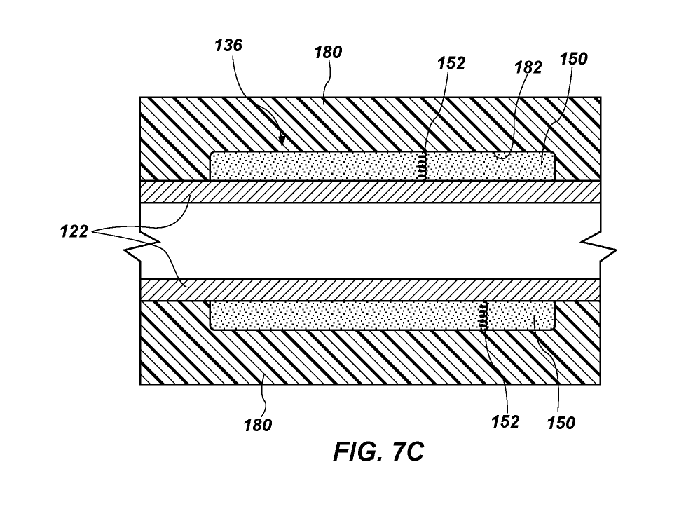

In some embodiments, the deformable material 150 may be disposed around the outer surface of the tubular component 122 by using a molding process, such as a reaction injection molding process, to mold the deformable material 150 around the tubular component 122, as illustrated in FIGS. 7A-7C.

As shown in FIG. 7A, a tubular component 122 may be positioned at least partially within a mold 180 having a mold cavity 182 therein. The mold cavity 182 may have a size and shape corresponding to the deformable material 150 to be formed therein around the tubular component 122. In some embodiments, the mold cavity 182 may have a size and shape corresponding to the size and shape of the deformable material 150 in the expanded state shown in FIG. 2B and FIG. 3B. Referring to FIG. 7B, the electrically conductive element 152 (or the electrically conductive element 172 of FIGS. 4A-4C) may be positioned within the mold cavity 182 at a selected position. The electrically conductive element 152 may be positioned within the mold cavity 182 before or after positioning the tubular component 122 at least partially within the mold 180. The electrically conductive element 152 may be disposed within the mold cavity 182 in the expanded state shown in FIGS. 2B and 4B. As shown in FIG. 7C, the deformable material 150 may be provided within the mold cavity 182 around the tubular component 122.

In some embodiments, the molding process used to form the deformable material 150 may comprise a reaction injection molding process. In such a process, a liquid precursor may be injected into the mold cavity 182 of the mold 180 as a liquid or paste. A chemical reaction may result in crosslinking between molecules (e.g., polymer chains or monomer units) so as to result in the formation of a non-flowable polymer material. The polymer material may be as previously described herein with reference to FIGS. 2A-2C. As previously mentioned, the deformable material 150 may comprise a shape memory polymeric material. In some embodiments, the deformable material 150 may be formed as described in the aforementioned '012 patent, previously incorporated herein by reference.

During the molding process, the electrically conductive element 152 may be bonded to the deformable material 150 as previously described herein. In particular, the CNTs in the carbon nanotube (CNT) material of the electrically conductive element 152 may be covalently bonded to the deformable material 150 as the deformable material 150 is formed around the tubular component 122.

For example, in some embodiments, the deformable material 150 may comprise polyurethane. In such embodiments, the polyurethane may be formed by, for example, reacting alcohols having two or more reactive hydroxyl groups per molecule (e.g., polyols) and isocyanates having more than one reactive isocyanate group per molecule within the mold cavity 182 of the mold 180. In some embodiments, the CNTs in the carbon nanotube (CNT) material of the electrically conductive element 152, 172 may be functionalized with amine groups prior to forming the deformable material 150 around or adjacent the electrically conductive element 152, 172. During the formation of the deformable material 150, the aminated carbon nanotubes may react with the isocyanates during the reaction injection molding process, resulting in the formation of covalent bonds between the CNTs of the CNT material and the polyurethane of the deformable material 150.

The deformable material 150 may be allowed to cure in the mold cavity 182 of the mold 180. As the deformable material 150 and the electrically conductive element 152, 172 may be formed in the expanded state, the deformable material 150 and the electrically conductive element 152, 172 are compressed. The deformable material 150 may be compressed until a diameter of the deformable material 150 has a diameter less than the diameter of the wall 132 of the wellbore 110 (FIG. 1), as previously described herein with reference to FIGS. 2A and 2B. As the deformable material 150 is compressed, the electrically conductive element 152, 172 may also be compressed to a compressed state, in which the length of the electrically conductive element 152, 172 is reduced as illustrated in FIGS. 2A and 4A.

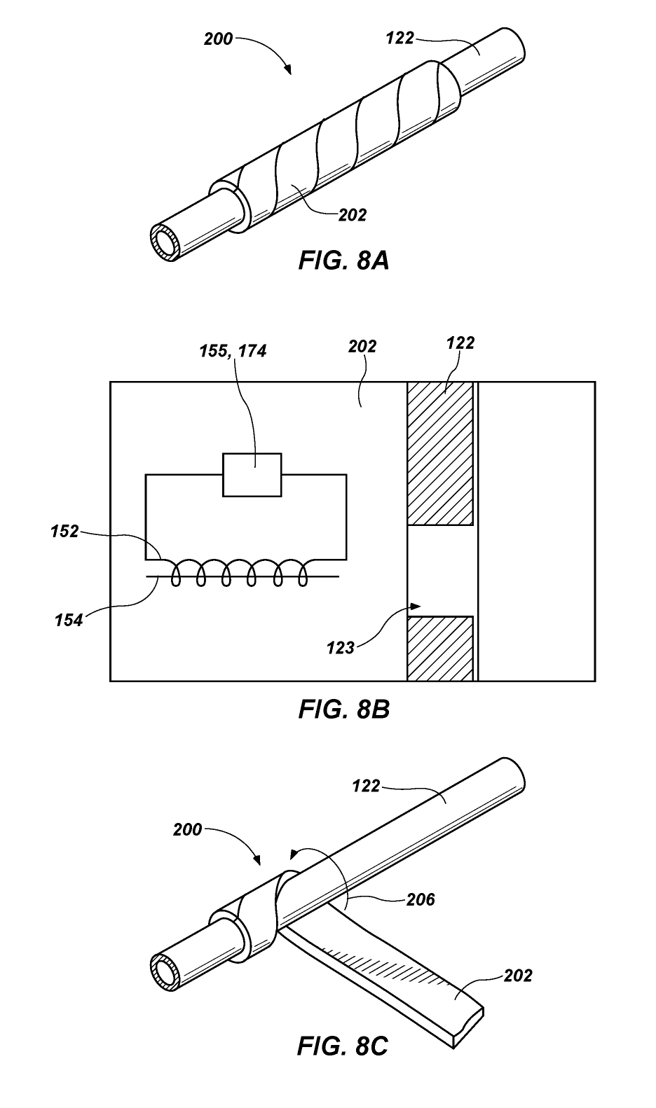

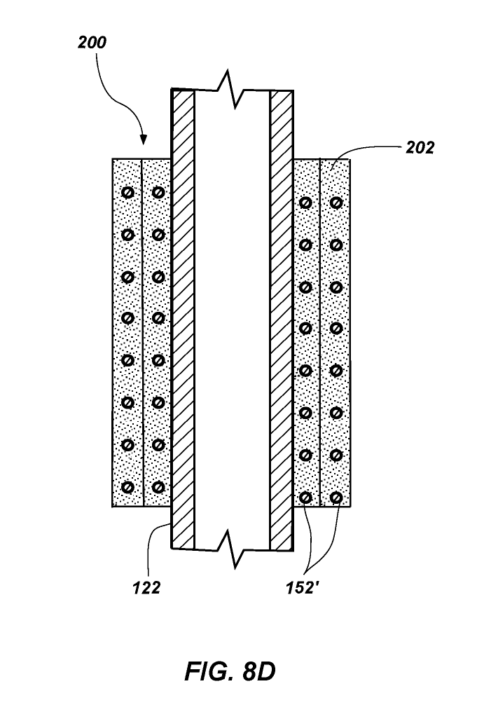

FIGS. 8A-8D illustrate another embodiment of a packer device 200 that may be employed in a wellbore system, such as the wellbore system 100 of FIG. 1. The packer device 200 is a deformable downhole article that, like the packer device 136, includes a tubular component 122. The deformable material 202 disposed around the tubular component 122 may comprise a rubber or elastomer. In some embodiments, the elastomer of the deformable material 202 may comprise the deformable material 150 as previously described herein with reference to FIGS. 2A-2C. For example, the deformable material 202 may be a rubber or elastomer as described in U.S. Patent Publication No. 2009/0139708, and the '708 patent, each of which was previously incorporated by reference herein.

FIG. 8B illustrates a partial cross-sectional view of the deformable material 202 having the electrically conductive element 152 disposed therein according to some embodiments. As previously described herein with reference to FIGS. 2A-2C, the electrically conductive element 152 may be oriented in the deformable material 202 such that the axis 154 of the coil extends perpendicular to the longitudinal axis of the tubular component 122 and radially outward from the tubular component 122 within the deformable material 150. In other words, the coils may be oriented in the deformable material 202 such that the axis 154 of the coil extends along a radius of the deformable material 202.

In other embodiments of the present disclosure, the electrically conductive element 152 is disposed in the deformable material 202 such that the electrically conductive element 152 may extend entirely around the circumference of the tubular component 122 one or more times in a helical manner. For example, as illustrated in FIG. 8D, the electrically conductive element 152 comprises a fiber arranged in a coil that extends concentrically and helically around the tubular component 122 within the deformable material 202. In other words, the electrically conductive element 152 may be oriented in the deformable material 202 such that an axis 204 of the coil extends parallel to the longitudinal axis of the tubular component 122. In each embodiment illustrated in FIGS. 8A-8D, the electrically conductive element 152 is located and configured such that stress will be applied to the electrically conductive element 152 upon swelling of the deformable material 202. For example, with regard to the embodiment of the electrically conductive element 152 illustrated in FIG. 8B, as the deformable material 202 expands from a compressed state to an expanded state, the length of the electrically conductive elements 152 may increase resulting in a change in at least one electrical property of the electrically conductive element 152. With regard to the embodiments of the electrically conductive element 152 illustrated in FIG. 8D, as the deformable material 202 expands from a compressed state to an expanded state, the diameter of the electrically conductive elements 152 may increase resulting in a change in at least one electrical property of the electrically conductive element 152. The measured electrical property of the electrically conductive element 152 may be correlated to a degree of expansion of the deformable material 202. The electrically conductive element 152 may be strained responsive to the imparted stress without extensive relative displacement of the electrically conductive element 152 relative to the adjacent deformable material 202 along the interface therebetween. Strain of the electrically conductive element 152 may result in a measurable change in the induction or electromagnetic field emitted about the electrically conductive element 152, which may be measured as a function of power loss or resonant frequency measured in the induction logging tool 140, as described previously herein with reference to FIGS. 2A through 2C. Strain of the electrically conductive element 152 may also be measured by coupling the electrically conductive element 152 to an electrical component 174, a power supply 164, and an electronic device 156, as described previously herein with reference to FIGS. 4A through 4C. In yet other embodiments, electrically conductive elements disposed in the deformable material 202 may have any other shape configured such that stress will be applied to the electrically conductive element 152 upon swelling of the deformable material 202.

Embodiments of the present disclosure also include methods of forming deformable downhole articles, such as the packer device 200. For example, in accordance with such methods, the deformable material 202 may be disposed around an outer surface of the tubular component 122 configured for placement in a wellbore, and an electrically conductive element 152 comprising a carbon nanotube (CNT) material bonded to the deformable material 202, as previously described herein with reference to FIGS. 2A-2C, 4A-4C, and 6.

In some embodiments, the electrically conductive element 152 may be disposed in and bonded to the rubber or elastomer of the deformable material 202 when the deformable material 202 is in an uncured state. The deformable material 202 may be cured on a curing mandrel in a manner known in the art in some embodiments. In other embodiments, the deformable material 202 may be cured on the tubular component 122. For example, the deformable material 202 may be cured by a method as described in U.S. Patent Publication No. 2009/0139708, previously incorporated herein by reference. The deformable material 202 in a cured or uncured state and having the electrically conductive element 152 disposed therein may be wrapped onto the tubular component 122, as in the direction depicted by arrow 206 illustrated in FIG. 8C.

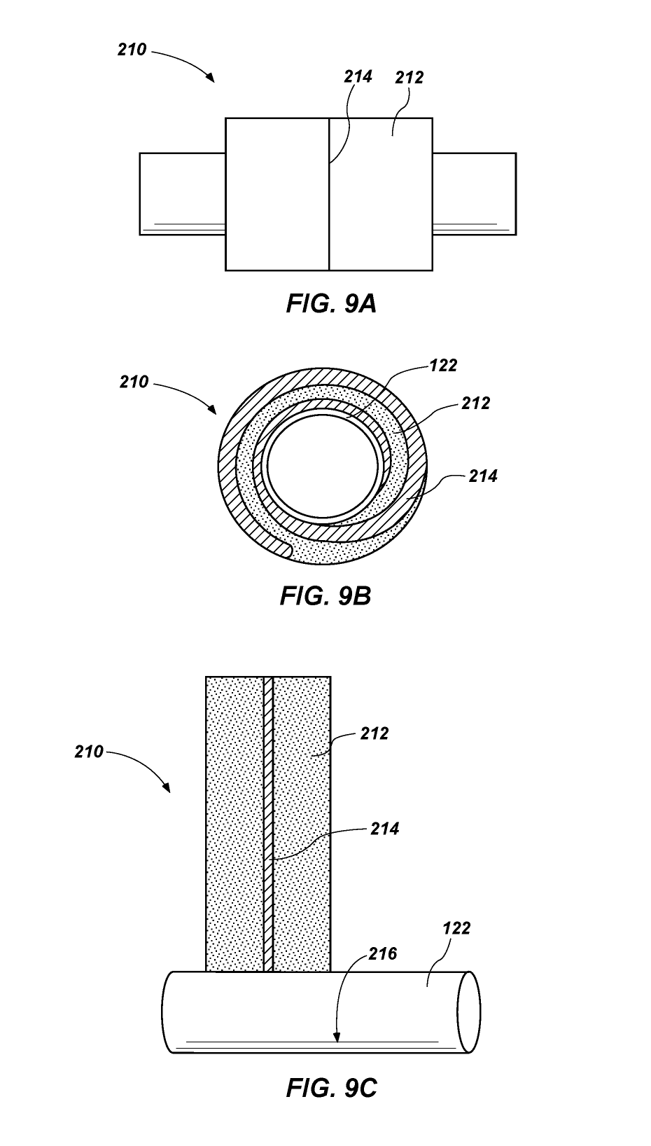

In some embodiments, more than one layer of deformable material 202 may be provided about the tubular component 122, as illustrated in FIG. 8D. For example, between four and six layers of deformable material may be provided about the tubular component 122. Each layer of deformable material 202 may comprise an electrically conductive element 152. In some embodiments, each layer of deformable material 202 may comprise a separate electrically conductive element 152. In other embodiments, the same electrically conductive element 152 may be provided through each layer of deformable material 202. In such embodiments, the electrically conductive element 152 may be helically wound about the tubular component 122 such that the electrically conductive element 152 ascends the tubular component 122 and descends the tubular component 122 (with regard to the view in FIG. 8D) between adjacent layers of deformable material 202. In each of the embodiments, each electrically conductive element 152 may be wound about the tubular component 122 in the same rotational direction (e.g., clockwise or counter-clockwise). FIGS. 9A-9C illustrate another embodiment of a packer device 210 that may be employed in a wellbore system, such as the wellbore system 100 of FIG. 1. The packer device 210 is a deformable downhole article that, like the packer device 136, includes a tubular component 122. The packer device 210 further comprises a deformable material 212, like the deformable material 202, previously described herein with reference to FIGS. 8A-8C. An electrically conductive element 214 may be disposed in the deformable material 212. The electrically conductive element 214 may be disposed in the deformable material 212 in an uncured state, as previously described herein with reference to FIGS. 8A-8C.

The electrically conductive element 214 comprises a fiber arranged in a coil that extends concentrically around the tubular component 122 within the deformable material 212. In some embodiments, the electrically conductive element 214 may comprise a carbon nanotube (CNT) material bonded to the deformable material 202, as previously described herein with reference to FIGS. 2A-2C, 4A-4C, and 6. In other embodiments, the electrically conductive element 214 may comprise a carbon nanotube (CNT) wire disposed within the deformable material 202. FIG. 9B is a cross-sectional view of the packer device 210 taken in a plane transverse to the longitudinal axis of the tubular component 122. As shown in FIG. 9B, the electrically conductive element 214 extends circumferentially around at least a portion of the tubular component 122. The electrically conductive element 214 may extend entirely around the circumference of the tubular component 122 one or more times in a circular or helical manner. Although only one electrically conductive element 214 is illustrated in FIGS. 9A-9C, any number of electrically conductive element 214 may be employed in embodiments of the present disclosure. In embodiments in which a plurality of electrically conductive elements 214 are employed, each electrically conductive element 214 may extend entirely around the circumference of the tubular component 122 one or more times.

In some embodiments, the ends of the electrically conductive element 214 may be in direct or indirect electrical contact. For example, the ends of the electrically conductive element 214 may be connected in an electrical circuit. In other words, the ends of the electrically conductive element 214 may be connected to the electrical component 155, as described previously herein with reference to FIGS. 2A-3C, or the electrical component 174, as described previously herein with reference to FIGS. 4A-5C. In other embodiments, the ends of the electrically conductive element 214 may be directly coupled to each other.

The deformable material 212 having the electrically conductive element 214 disposed therein may be formed about the tubular component 122, as previously described herein with reference to FIGS. 8A-8D. For example, the deformable material 212 having the electrically conductive element 214 disposed therein may be wrapped about the tubular component 122 in the direction depicted by arrow 216 illustrated in FIG. 9C.

The electrically conductive element 214 is located and configured such that stress will be applied to the electrically conductive element 214 upon swelling of the deformable material 212. The electrically conductive element 214 may be strained responsive to the imparted stress without extensive relative displacement of the electrically conductive element 152 relative to the adjacent deformable material 212 along the interface therebetween. Strain of the electrically conductive element 214 may result in a measurable change in the induction or electromagnetic field emitted about the electrically conductive element 214, which may be measured as a function of power loss or resonant frequency measured in the induction logging tool 140, as described previously herein with reference to FIGS. 2A through 2C and as illustrated in FIG. 9B. Strain of the electrically conductive element 214 may also be measured by coupling the electrically conductive element 152 to an electrical component 174, a power supply 164, and an electronic device 156, as described previously herein with reference to FIGS. 4A through 4C. In yet other embodiments, electrically conductive elements disposed in the deformable material 212 may have any other shape configured such that stress will be applied to the electrically conductive element 214 upon swelling of the deformable material 212. With regard to the embodiments of the electrically conductive element 152 illustrated in FIG. 9B, as the deformable material 212 expands from a compressed state to an expanded state, the diameter of the electrically conductive element 214 may increase resulting in a change in at least one electrical property of the electrically conductive element 214. The change in at least one electrical property of the electrically conductive element 214 may be correlated to a degree of expansion of the deformable material 212.

In yet additional embodiments, the present disclosure includes methods of using a deformable downhole article in a wellbore 110, such as the packer device 136, the packer device 170, the packer device 200, or the packer device 210. For example, the packer device 136, 170, 200, 210 may be positioned within a wellbore 110 at a desired location while the deformable material 150, 202, 212 is in an unswollen or compressed state (e.g., the states shown in FIGS. 2A and 4A). The deformable material 150, 202, 212 then may be caused to swell or expand to an expanded state (e.g., the states shown in FIGS. 2B and 4B) at the selected location in the wellbore 110. The deformable material 150, 202, 212 may be caused to swell (e.g. expand) by application of a stimulus (e.g., exposure to the wellbore 110 environment). The stimulus may be a thermal stimulus, a chemical stimulus, an electrical stimulus, etc. Swelling or expansion of the deformable material 150, 202, 212 may further result in expansion of the electrically conductive element 152, 172, 214 as the electrically conductive element 152, 172, 214 is located and configured such that stress is applied to the electrically conductive element 152, 172, 214 by the deformable material 150, 202, 212.

As previously mentioned, expansion of the deformable material 150, 202, 212 may alter a strain state of the carbon nanotube (CNT) material of the electrically conductive element 152, 172, 214 which may cause the at least one electrical property (e.g., inductance, resistivity, impedance, etc.) of the electrically conductive element 152, 172, 214 to change. As a result, the electronic device 156 or the induction logging tool 140 of the packer device 136, 170, 200, 210 may be used to measure the change in at least one electrical property of the electrically conductive element 152, 172, 214 either directly or indirectly, as previously described herein, during and/or after expansion of the deformable material 150, 202, 212. As a result, the rate of expansion and/or the extent of the expansion of the deformable material 150, 202, 212 may be determined so as to ensure that the deformable material 150, 202, 212 has expanded as intended, and that the packer device 136, 170, 200, 210 will safely operate as intended. For example, the measurement of the at least one electrical property of the electrically conductive element 142, 172, 214 may correlate to a degree of expansion of the deformable material 150, 202, 212.

In some embodiments, the induction logging tool 140 may be used to ensure that the deformable material 150, 202, 212 has uniformly expanded. As previously discussed with respect to, for example, FIGS. 2A and 2B, a plurality of electrically conductive elements 152 may be dispersed in the deformable material 150 concentrically about the tubular component and along a length of the tubular component 122. The induction logging tool 140 may be disposed in the tubular component 122 adjacent the deformable material 150. The induction logging tool 140 may be rotated about a central axis thereof such that the transmitter coil 143 may be substantially aligned with each electrically conductive element 152 extending radially outward from a portion of the tubular component 122 and dispersed concentrically about the tubular component 122 within the deformable material 150. Measurements of at least one electrical property of each electrically conductive element 152 may be taken. As previously discussed, a measurement of the electrical property of the electrically conductive element 150 may be correlated to a degree of expansion of the deformable material. As a result, the uniformity or non-uniformity of expansion of the deformable material 150 may be determined by comparing the respective electrical property measurements of each electrically conductive element 152 in the deformable material 150.

In yet other embodiments, the induction logging tool 140 may be movable within and along the tubular component 122. The induction logging tool 140 may be conveyed from the surface 126 of the subterranean formation 112 into the tubular component 122. The induction logging tool 140 may also be conveyed through the tubular component 122 between a plurality of packer devices 136, 170, 200, and 210, which may be provided along the tubular component 122, as illustrated in FIG. 1. For example, the transmitter coils 143 and receiver coils 144 of the induction logging tool 140 may continuously induce electromagnetic fields and detect voltage signals induced by eddy currents flowing through subterranean formation 112 and through the electrically conductive elements 152, 172, 214 disposed in the deformable material 150, 202, 212 of the respective packer device 136, 170, 200, and 210. The signals received by the induction logging tool 140 may be interpreted to differentiate between eddy currents detected from the subterranean formation 112 and the electrically conductive elements 152, 172, 214. As a result, the induction logging tool 140 may be used to determine the location and presence of a packer device 136, 170, 200, and 210 in the wellbore 110. Although the disclosure has described embodiments of a deformable downhole article including an electrically conductive element formed of a carbon nanotube (CNT) material, the invention is not so limited. For example, the electrically conductive element incorporated in the deformable downhole article may comprise any electrically conductive material including, but not limited to, electrically conductive metals, such as conductive silicon or carbon nanowires and non-metallic conductive materials. In some embodiments, the electrically conductive elements may optionally be coated with a dielectric material and embedded in the deformable material according to any of the embodiments of the present disclosure. The dielectric material may be provided to prevent degradation or corrosion of the electrically conductive elements described herein due to the corrosive conditions, including, but not limited to, high temperatures, high pressures, reactive or corrosive chemicals, and abrasive materials, the deformable downhole articles may be exposed to in the wellbore 110. The dielectric material may comprise any electrically insulating material. In some embodiments, the electrically insulating material may comprise an electrically insulating polymer. For example, the electrically insulating material may comprise polytetrafluorethylene (PTFE), ethylene propylene diene monomer (EPDM) rubber, or fiberglass.

Additional non-limiting example embodiments of the present disclosure are set forth below.

### Embodiment 1

A deformable downhole article for use in a wellbore, comprising: a tubular component configured for placement in a wellbore; a deformable material disposed around an outer surface of the tubular component; and an electrically conductive element comprising a carbon nanotube (CNT) material bonded to the deformable material.

### Embodiment 2

The deformable downhole article of Embodiment 1, wherein the electrically conductive element is located and configured such that stress will be applied to the electrically conductive element upon swelling of the deformable material and the electrically conductive element is strained responsive to the applied stress.

### Embodiment 3

The deformable downhole article of Embodiment 1 or Embodiment 2, further comprising an electronic device operably coupled to the electrically conductive element and configured to measure at least one electrical property of the electrically conductive element.

### Embodiment 4

The deformable downhole article of any one of Embodiments 1 through 3, wherein the CNT material extends radially outward from at least a portion of the tubular component.

### Embodiment 5

The deformable downhole article of any one of Embodiments 1 through 3, wherein the CNT material comprises crosslinked carbon nanotubes, and the CNT material extends

### Embodiment 6

The deformable downhole article of any one of Embodiments 1 through 5, wherein the electrically conductive element is covalently bonded to the deformable material.

### Embodiment 7

The deformable downhole article of any one of Embodiments 1 through 6, wherein the CNT material comprises crosslinked carbon nanotubes (CNTs), and wherein CNTs of the CNT material are covalently bonded to the deformable material.

### Embodiment 8

The deformable downhole article of any one of Embodiments 1 through 7, wherein the electrically conductive element is disposed within the deformable material.

### Embodiment 9

The deformable downhole article of any one of Embodiments 1 through 8, wherein CNTs of the CNT material are impregnated with metal nanoparticles.

### Embodiment 10

The deformable downhole article of Embodiment 9, wherein the metal nanoparticles comprise palladium nanoparticles.

### Embodiment 11

The deformable downhole article of Embodiment 7, wherein CNTs of the CNT material are crosslinked with benzoquinone.

### Embodiment 12

The deformable downhole article of any one of Embodiments 1 through 11, wherein the deformable material comprises a shape memory polymer.

### Embodiment 13

The deformable downhole article of Embodiment 12, wherein the shape memory polymer comprises polyurethane.

### Embodiment 14

A method of forming a deformable downhole article for use in a wellbore, comprising: disposing a deformable material around an outer surface of a tubular component configured for placement in a wellbore; and bonding an electrically conductive element comprising a carbon nanotube (CNT) material to the deformable material.

### Embodiment 15

The method of Embodiment 14, wherein disposing the deformable material around the outer surface of the tubular component comprises molding the deformable material around the tubular component.

### Embodiment 16

The method of Embodiment 15, wherein molding the deformable material around the tubular component comprises a reaction injection molding process.

### Embodiment 17

The method of any one of Embodiments 14 through 16, wherein bonding the electrically conductive element comprising the carbon nanotube (CNT) material to the deformable material comprises covalently bonding the electrically conductive element to the deformable material.

### Embodiment 18

A method of using a deformable downhole article in a wellbore, comprising: positioning a deformable downhole article in a wellbore, the deformable downhole article includes a tubular component, a deformable material disposed around an outer surface of the tubular component, and an electrically conductive element comprising a carbon nanotube (CNT) material bonded to the deformable material; expanding the deformable material to an expanded state in the wellbore, expansion of the deformable material straining the carbon nanotube (CNT) material of the electrically conductive element; and measuring an electrical property of the electrically conductive element.

### Embodiment 19

The method of Embodiment 18, wherein measuring the electrical property of the electrically conductive element comprises measuring a resistivity or inductance of the electrically conductive element.

### Embodiment 20

The method of Embodiment 18 or Embodiment 19, further comprising correlating a measurement obtained by the measuring of the electrical property of the electrically conductive element to a degree of expansion of the deformable material.

### Embodiment 21

The method of any one of Embodiments 18 through 20, wherein the electrically conductive element is covalently bonded to the deformable material.

### Embodiment 22

A method of using a deformable downhole article in a wellbore, comprising: positioning a deformable downhole article in a wellbore, the deformable downhole article including a tubular component, a deformable material disposed around an outer surface of the tubular component, and an electrically conductive element disposed in the deformable material; expanding the deformable material to an expanded state in the wellbore, wherein expansion of the deformable material applies stress to the electrically conductive element; measuring at least one electrical property of the electrically conductive element associated with strain of the electrically conductive element responsive to the applied stress; and correlating the at least one measured electrical property to a degree of expansion of the deformable material.

### Embodiment 23

The method of Embodiment 21, wherein measuring the at least one electrical property of the electrically conductive element comprises measuring at least one electrical property of the electrically conductive element using an induction logging tool.

### Embodiment 24

The method of Embodiments 21 or 22, wherein measuring the at least one electrical property of the electrically conductive element comprises conveying the induction logging tool from a surface of a subterranean formation through the tubular component to the deformable downhole article; and determining a location of the deformable downhole article in the wellbore.

### Embodiment 25

The method of any of Embodiments 21 through 24, wherein measuring the at least one electrical property of the electrically conductive element comprises rotating the induction logging tool about a central axis thereof and within a portion of the tubular component adjacent to the deformable material, the deformable material comprising a plurality of electrically conductive elements extending radially outward from at least a portion of the tubular component and provided concentrically about the tubular component; measuring at least one electrical property of each of the plurality of electrically conductive elements; and comparing the electrical property measurements of each of the plurality of electrically conductive elements disposed in the deformable material and determining a degree of uniformity of expansion of the deformable material.

### Embodiment 26

The method of Embodiment 21, wherein measuring the at least one electrical property of the electrically conductive element comprises measuring the at least one electrical property of the electrically conductive element using at least one electrical component and a power supply coupled to the electrically conductive element.

### Embodiment 27

The method of Embodiments 21 or 26, wherein measuring the change in at least one electrical property of the electrically conductive element using the at least one electrical component and the power supply comprises passing an electrical current from the power supply through the at least one electrical component and the electrically conductive element; and measuring at least one of inductance, resistivity, or impedance of the electrically conductive element.

### Embodiment 28

The method of any of Embodiments 21, 26, and 27, further comprising selecting the at least one electrical component to comprise at least one of a capacitor or a resistor.

### Embodiment 29

The method of any of Embodiments 21 and 26 through 28, further comprising determining a degree of expansion of the deformable material from the at least one electrical property measurement of the electrically conductive component.

### Embodiment 30

The method of any of Embodiments 21 through 29, wherein the electrically conductive element comprises a carbon nanotube (CNT) material.

### Embodiment 31

The method of any of Embodiments 21 through 30, wherein the electrically conductive element comprises an electrically conductive metal.

### Embodiment 32

The method of any of Embodiments 21 through 31, wherein the electrically conductive element is covalently bonded to the deformable material such that expanding the deformable material to the expanded state in the wellbore comprises imparting stress on the electrically conductive element without extensive relative displacement of the electrically conductive element relative to the deformable material.

### Embodiment 33

The method of any of Embodiments 21 through 32, wherein expanding the deformable material to the expanded state in the wellbore comprises increasing a length of the electrically conductive element.

### Embodiment 34

The method of any of Embodiments 21 through 33, wherein expanding the deformable material to the expanded state in the wellbore comprises increasing a diameter of the electrically conductive element.

### Embodiment 35

A method of using a deformable downhole article in a wellbore, comprising: positioning a deformable downhole article in a wellbore, the deformable downhole article including a tubular component, a deformable material disposed around an outer surface of the tubular component, and a plurality of electrically conductive elements disposed in the deformable material; expanding the deformable material to an expanded state in the wellbore, wherein expansion of the deformable material applies stress to one or more of the plurality of electrically conductive elements; disposing an induction logging tool within the tubular component; measuring at least one electrical property of each of the plurality of electrically conductive elements using the induction logging tool, the at least one electrical property of the one or more of the plurality of electrically conductive elements being altered by strain thereof responsive to the applied stress; and correlating the at least one electrical property measurement to a degree of expansion of the deformable material.

### Embodiment 36

The method of Embodiment 35, further comprising comparing the at least one electrical property measurement of each of the plurality of electrically conductive elements and determining a degree of uniformity of expansion of the deformable material.

### Embodiment 37

The method of Embodiments 35 and 36, further comprising determining a location of the deformable downhole article in the wellbore using the induction logging tool.

### Embodiment 38

The method of any of Embodiments 35 through 37, wherein the electrically conductive elements comprise a carbon nanotube (CNT) material.

### Embodiment 39

The method of any of Embodiments 35 through 38, wherein the electrically conductive elements comprise an electrically conductive metal.

### Embodiment 40

A deformable downhole article for use in a wellbore, comprising: a tubular component configured for placement in a wellbore; a deformable material disposed around an outer surface of the tubular component; and an electrically conductive element disposed in the deformable material, the electrically conductive element comprising an electrically conductive element arranged as a coil.

### Embodiment 41

The deformable downhole article of Embodiment 40, further comprising means for measuring at least one electrical property of the electrically conductive element.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope of the disclosure as contemplated by the inventors.

What is claimed is:

1. A method of using a deformable downhole article in a wellbore, comprising:
positioning a deformable downhole article in a wellbore, the deformable downhole article including a tubular component, a deformable material disposed around an outer surface of the tubular component, and an electrically conductive element disposed in the deformable material;
expanding the deformable material to an expanded state in the wellbore, wherein expansion of the deformable material applies stress to the electrically conductive element;
measuring at least one electrical property of the electrically conductive element associated with strain of the electrically conductive element responsive to the applied stress; and
correlating the at least one measured electrical property to a degree of expansion of the deformable material.

2. The method of claim 1, wherein measuring the at least one electrical property of the electrically conductive element comprises measuring at least one electrical property of the electrically conductive element using an induction logging tool.

3. The method of claim 2, wherein measuring the at least one electrical property of the electrically conductive element comprises:
conveying the induction logging tool from a surface of a subterranean formation through the tubular component to the deformable downhole article; and
determining a location of the deformable downhole article in the wellbore.

4. The method of claim 2, wherein measuring the at least one electrical property of the electrically conductive element comprises:
rotating the induction logging tool about a central axis thereof and within a portion of the tubular component adjacent to the deformable material, the deformable material comprising a plurality of electrically conductive elements extending radially outward from at least a portion of the tubular component and provided concentrically about the tubular component;
measuring at least one electrical property of each of the plurality of electrically conductive elements; and
comparing the electrical property measurements of each of the plurality of electrically conductive elements disposed in the deformable material and determining a degree of uniformity of expansion of the deformable material.

5. The method of claim 1, wherein measuring the at least one electrical property of the electrically conductive element comprises measuring the at least one electrical property of the electrically conductive element using at least one electrical component and a power supply coupled to the electrically conductive element.

6. The method of claim 5, wherein measuring the change in at least one electrical property of the electrically conductive element using the at least one electrical component and the power supply comprises:
passing an electrical current from the power supply through the at least one electrical component and the electrically conductive element; and
measuring at least one of inductance, resistivity, or impedance of the electrically conductive element.

7. The method of claim 5, further comprising selecting the at least one electrical component to comprise at least one of a capacitor or a resistor.

8. The method of claim 5, further comprising determining a degree of expansion of the deformable material from the at least one electrical property measurement of the electrically conductive component.

9. The method of claim 1, wherein the electrically conductive element comprises a carbon nanotube (CNT) material.

10. The method of claim 1, wherein the electrically conductive element comprises an electrically conductive metal.

11. The method of claim 1, wherein the electrically conductive element is covalently bonded to the deformable material such that expanding the deformable material to the expanded state in the wellbore comprises imparting stress on the electrically conductive element without extensive relative displacement of the electrically conductive element relative to the deformable material.

12. The method of claim 1, wherein expanding the deformable material to the expanded state in the wellbore comprises increasing a length of the electrically conductive element.

13. The method of claim 1, wherein expanding the deformable material to the expanded state in the wellbore comprises increasing a diameter of the electrically conductive element.

14. A method of using a deformable downhole article in a wellbore, comprising:
positioning a deformable downhole article in a wellbore, the deformable downhole article including a tubular component, a deformable material disposed around an outer surface of the tubular component, and a plurality of electrically conductive elements disposed in the deformable material;
expanding the deformable material to an expanded state in the wellbore, wherein expansion of the deformable material applies stress to one or more of the plurality of electrically conductive elements;
disposing an induction logging tool within the tubular component;
measuring at least one electrical property of each of the plurality of electrically conductive elements using the induction logging tool, the at least one electrical property of the one or more of the plurality of electrically conductive elements being altered by strain thereof responsive to the applied stress; and
correlating the at least one electrical property measurement to a degree of expansion of the deformable material.

15. The method of claim 14, further comprising comparing the at least one electrical property measurement of each of the plurality of electrically conductive elements and determining a degree of uniformity of expansion of the deformable material.

16. The method of claim 14, further comprising determining a location of the deformable downhole article in the wellbore using the induction logging tool.

17. The method of claim 14, wherein the electrically conductive elements comprise a carbon nanotube (CNT) material.

18. The method of claim 14, wherein the electrically conductive elements comprise an electrically conductive metal.

19. A deformable downhole article for use in a wellbore, comprising:
a tubular component configured for placement in a wellbore;
a deformable material disposed around an outer surface of the tubular component; and
an electrically conductive element disposed in the deformable material, the electrically conductive element comprising an electrically conductive element arranged as a coil.

20. The deformable downhole article of claim 19, further comprising means for measuring at least one electrical property of the electrically conductive element.
